(19) United States
(12) Patent Application Publication
(10) Pub. No.: US 2019/0014793 A1
(43) Pub. Date: Jan. 17, 2019

(54) METHOD OF PROVIDING NUTRITION TO INFANTS

(71) Applicant: ABBOTT LABORATORIES, Abbott Park, IL (US)

(72) Inventors: CATHERINE S. LAMB, Westerville, OH (US); STEVEN T. LUEBBERS, Columbus, OH (US); KANDICE T. TUCKER, Columbus, OH (US); PAUL W. JOHNS, Columbus, OH (US); BRIDGET BARRETT-REIS, Dublin, OH (US)

(73) Assignee: ABBOTT LABORATORIES, Abbott Park, IL (US)

(21) Appl. No.: 16/135,636

(22) Filed: Sep. 19, 2018

Related U.S. Application Data
(63) Continuation of application No. 14/346,971, filed on Mar. 25, 2014.
(60) Provisional application No. 61/547,337, filed on Oct. 14, 2011.

(51) Int. Cl. A23J 3/10; A23L 33/19; A23L 33/18; A23C 9/152; A23C 9/20; A23J 3/30; A23L 33/00

(52) U.S. Cl. CPC A23J 3/10; A23L 33/19; A23L 33/18; A23L 33/40; A23C 9/206; A23J 3/30; A23C 9/1526

(57) ABSTRACT

Disclosed are methods of providing nutrition to infants, as well as sterilized liquid protein supplements including extensively hydrolyzed casein for use with human milk and other infant feeding formulas. The sterilized liquid protein supplements have a low pH, thereby inhibiting protein denaturation and reducing microbial growth.

### CROSS REFERENCE TO RELATED APPLICATIONS

This application is a continuation of U.S. patent application Ser. No. 14/346,971, filed on Mar. 25, 2014, which is the U.S. national stage entry of International Application No. PCT/US2012/059940, filed Oct. 12, 2012, which claims priority to and any other benefit of U.S. Provisional Application No. 61/547,337, filed Oct. 14, 2011, the entire contents of which are herein incorporated by reference.

### FIELD OF THE DISCLOSURE

The present disclosure relates to a sterilized liquid protein supplement. More particularly, the present disclosure relates to a low acid, long term stable, sterilized liquid protein supplement including extensively hydrolyzed casein. In some embodiments, the sterilized liquid protein supplement is substantially free of collagen.

### BACKGROUND OF THE DISCLOSURE

Human milk is generally recognized as an ideal feeding for most infants due to its overall nutritional composition. It is well known and generally accepted that human milk provides infants with unique immunologic and developmental benefits as compared generally to commercially available infant formulas.

For some infants, however, especially preterm infants, human milk does not always meet the complete nutritional needs. Further many mothers are not able to provide sufficient human milk to their infants. Under these circumstances, infant formulas are commonly used to provide supplemental or sole source nutrition early in life.

Although infants still generally benefit from human milk and/or commercially available infant formulas, it is often desirable to supplement their feedings with additional nutrients. Protein supplements have been previously used to supplement the protein intake of infants, particularly, preterm and low birth weight infants.

Most of the protein supplements described in the literature and commercially available have been formulated as reconstitutable powders rather than liquids in order to minimize the volume displacement of human milk or liquid infant formulas by the supplement. It is recently been found, however, that liquid protein supplements, and specifically highly concentrated liquid protein supplements, are desirable as an alternative to powders as these liquids have the significant benefit of being commercially sterile as they can be subjected to sufficient heat treatment during manufacturing, including ultra high temperature (UHT) treatment.

To date, however, liquid protein supplements are typically highly acidic, which can be problematic as the acidity of the supplement can change its natural properties, e.g., proteins may denature, which may have an adverse impact, when fed to an infant. Moreover, many protein supplements are based wholly or in large part on collagen as the protein source. Collagen, however, is an inferior protein source, and as such, supplements including significant amounts of collagen are not acceptable for neonate consumption.

As such, there is a need for sterilized liquid protein supplements that are sufficiently long term stable that include hypoallergenic proteins, such as extensively hydrolyzed casein proteins. Additionally, it would be very beneficial if the sterilized liquid protein supplements could be made to have a neutral pH such as to prevent protein denaturation when added to human milk and have the milk remain a neutral pH.

### SUMMARY OF THE DISCLOSURE

The present disclosure is directed to long term stable sterilized liquid protein supplements including extensively hydrolyzed casein. In some embodiments, the extensively hydrolyzed casein is the sole source of protein in the sterilized liquid protein supplement. The sterilized liquid protein supplements may be, in some embodiments, clear and/or hypoallergenic.

The present disclosure is specifically directed to a sterilized liquid protein supplement comprising more than 10 grams protein per 100 mL. At least a portion of the protein is extensively hydrolyzed casein. The sterilized liquid protein supplement has a pH of from about 5.0 to about 8.0.

The present disclosure is further specifically directed to a sterilized liquid protein supplement comprising more than 10 grams extensively hydrolyzed casein per 100 mL. The sterilized liquid protein supplement is substantially free of collagen.

The present disclosure is further specifically directed to a sterilized clear liquid protein supplement comprising more than 10 grams protein per 100 mL. At least a portion of the protein is extensively hydrolyzed casein. The sterilized liquid protein supplement has a pH of from about 5.0 to about 8.0.

The present disclosure is further specifically directed to a sterilized clear liquid protein supplement comprising more than 10 grams extensively hydrolyzed casein per 100 mL. The sterilized liquid protein supplement is substantially free of collagen and has a pH of from about 5.0 to about 8.0.

The present disclosure is further specifically directed to a method of manufacturing a liquid protein supplement. The method comprises: suspending a protein in an aqueous solution using agitation to form a protein suspension mixture, wherein at least a portion of the protein is extensively hydrolyzed casein, and wherein the protein suspension mixture has a protein concentration of greater than 30% by weight; diluting the protein suspension mixture with water to form a diluted mixture having a protein concentration of from about 25% to about 30% by weight; heating the diluted mixture with agitation to a temperature of from about 150° F. to about 210° F.; emulsifying the heated mixture at from 0 to about 500 psig; heating the emulsified mixture at a first temperature of from about 240° F. to about 260° F.; further heating the emulsified mixture at a second temperature of from about 275° F. to about 305° F. and holding the heated emulsified mixture at the second temperature for a period of from about 1 second to about 5 seconds; cooling the heated emulsified mixture to a temperature of from about 150° F. to about 200° F.; homogenizing the cooled mixture at from 0 to about 500 psig and holding the homogenized cooled mixture at the temperature of from about 150° F. to about 200° F. for a period of from about 10 seconds to about 20 seconds; further cooling the homogenized mixture to a temperature of less than about 100° F.; and diluting the cooled homogenized mixture with water to form a cooled homogenized mixture comprising more than 10 grams protein per 100 mL.

The present disclosure is further specifically directed to a method of fortifying breast milk. The method comprises mixing a sterilized liquid protein supplement with breast milk. The sterilized liquid protein supplement comprises more than 10 grams protein per 100 mL, wherein at least a portion of the protein is extensively hydrolyzed casein. Suitable ratios for the addition of sterilized liquid protein supplement to breast milk comprises from about 1 mL to about 5 mL of sterilized liquid protein supplement to 100 mL of fortified breast milk to result in from about 3.2 grams of protein per 100 kcal to about 4 grams of protein per 100 kcal. Additionally, the sterilized liquid protein supplement has a pH of from about 5.0 to about 8.0.

The present disclosure is further specifically directed to a method of fortifying infant formula, and particularly preterm infant formula. The method comprises mixing a sterilized liquid protein supplement with infant formula. The sterilized liquid protein supplement comprises more than 10 grams protein per 100 mL, wherein at least a portion of the protein is extensively hydrolyzed casein. Suitable ratios for the addition of sterilized liquid protein supplement to infant formula comprises from about 1 mL to about 5 mL of sterilized liquid protein supplement to 100 mL of infant formula to result in from about 3.2 grams of protein per 100 kcal to about 4 grams of protein per 100 kcal. Additionally, the sterilized liquid protein supplement has a pH of from about 5.0 to about 8.0.

It has been unexpectedly found that stable sterilized liquid protein supplements can advantageously be prepared as clear solutions having a high concentration of protein, and in particular, having a high concentration of extensively hydrolyzed protein. Further, it has been found that the liquid protein supplements can be sufficiently concentrated so as to not unacceptably dilute the other components of human milk or other infant formulas.

Additionally, the neutral pH levels of the sterilized liquid protein supplements prevent denaturation of the proteins in human milk or other infant formulas to be supplemented with the liquid protein supplement, thereby allowing for sufficient protein supplementation to infants, particularly preterm and low birth weight infants. Further, the pH levels allow the sterilized liquid protein supplements to be added to human milk without the need for adjusting the pH of the final liquid product.

Additionally, it has been unexpectedly discovered that sterilized liquid protein supplements can be prepared without the use of collagen, and more particularly, to include higher amounts of high nutritional quality extensively hydrolyzed proteins, which provide an improved source of protein. In some embodiments, the sterilized liquid protein supplement may include up to 100% extensively hydrolyzed casein (by weight of the protein component).

The sterilized liquid protein supplements may further be prepared to include predominately free amino acids, dipeptides and tripeptides. For example, the sterilized liquid protein supplements of the present disclosure may include at least 50%, including at least 60%, and further including at least 75% by weight total protein content, free amino acids, di-peptides and tri-peptides.

In some embodiments, the sterilized liquid protein supplements include more than 10 grams protein per 100 mL, including from about 14 grams to about 30 grams protein per 100 mL, including from about 17 grams to about 24 grams protein per 100 mL, and including from about 20 grams to about 23.5 grams protein per 100 mL. It has been unexpectedly found that protein supplements having a protein concentration of greater than 10 grams protein per 100 mL yields a solution that provides acceptable amounts of protein while providing a stable solution that does not visually change in appearance when stored at room temperature or refrigerated temperature before use. Particularly, a stable sterilized liquid protein supplement including from about 20 grams to about 23.5 grams protein per 100 mL has been prepared as a stable clear solution, which is unexpected due to the solubility limits of specific amino acids in the protein.

Further, solubility is expected to decrease when the temperature is decreased, however, it has been found that even samples of the sterilized liquid protein supplement of the present disclosure that display sediment due to having protein concentrations above 23.2 grams protein per 100 mL do not appear to have increased sediment when refrigerated versus when held at room temperature.

To further improve the stability of the sterilized liquid protein supplement, it has now been discovered that sterilized liquid protein supplements can be processed to have lower insoluble solids contents; that is, insoluble solids contents of less than 5 grams insoluble solids per 100 grams supplement, including from about 0.5 grams to less than 5 grams insoluble solids per 100 grams supplement, and more preferably, 0 grams insoluble solids per 100 grams supplement.

### BRIEF DESCRIPTION OF THE DRAWINGS

FIG. 1 is a graph depicting precipitation of insoluble matter as a function of increased protein concentration in a liquid protein supplement as analyzed in Example 2.

FIGS. 2A and 2B depict amino acid profile of casein hydrolysate as used in Example 4.

### DETAILED DESCRIPTION OF THE DISCLOSURE

The sterilized liquid protein supplements of the present disclosure generally comprise extensively hydrolyzed casein as a protein source and may optionally be substantially free of collagen. In some embodiments, the sterilized liquid protein supplements are substantially clear liquid protein supplements being substantially free of carbohydrate and fat. These and other essential or optional elements or limitations of the sterilized liquid protein supplements and methods of the present disclosure are described in detail hereinafter.

The terms “substantially clear liquid” or “substantially clear sterilized liquid protein supplement” as used herein, unless otherwise specified, are used interchangeably and refer to non-emulsified or similar other liquids having a visibly clear or translucent appearance, which liquid may and typically will have a thin or watery texture with a consistency similar to that of a clear juice and most typically having a viscosity of less than about 25 centipoises as determined by a Brookfield viscometer at 22° C. using a #1 spindle at 60 rpm.

The terms “sterile”, “sterilized” and “sterilization” as used herein, unless otherwise specified, refer to the reduction in transmissible agents such as fungi, bacteria, viruses, spore forms, and so forth, in food or on food grade surfaces to the extent necessary to render such foods suitable for human consumption. Sterilization processes may include various techniques involving the application of heat, peroxide or other chemicals, irradiation, high pressure, filtration, or combinations or variations thereof.

The term “retort packaging” and “retort sterilizing” are used interchangeably herein, and unless otherwise specified, refer to the common practice of filling a container, most typically a metal can or other similar package, with a liquid protein supplement and then subjecting the liquid-filled package to the necessary heat sterilization step, to form a sterilized, retort packaged, liquid protein supplement.

The term “infant” as used herein, refers generally to individuals less than about 1 year of age, actual or corrected.

The term “preterm” are used herein refers to those infants born at less than 37 weeks gestation, having a birth weight of less than 2500 gm, or both.

The term “total solids”, unless otherwise specified herein refers to all material components of the compositions of the present disclosure, less water.

The term “hypoallergenic” as used herein means that the sterilized liquid protein supplement has a decreased tendency to provoke an allergic reaction in a user, such as a preterm or term infant, as compared to non-hypoallergenic liquid supplements. More particularly, the sterilized liquid protein supplement is hypoallergenic when there is 95% confidence that 90% of allergic infants would not react to the supplement in a double-blind, placebo-controlled study. An example of a suitable DPBC study is described in Kleinman, et al. “Use of infant formulas in infants with cow milk allergy: a review and recommendations,” Pediatr Allergy Immunol 1991, 4: 146-155.

The term “extensively hydrolyzed' as used herein refers to protein that has been enzymatically or acidically hydrolyzed to have a degree of hydrolysis of at least 20%. Typically, extensively hydrolyzed proteins exists primarily as free amino acids, di- and tri-peptides.

The term “stable” as used herein means that the sterilized liquid protein supplement is resistant to separation and precipitation for a time period after manufacture of at least three months, and preferably at least six months.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the sterilized liquid protein supplements of the present disclosure may also be substantially free of any optional or selected essential ingredient or feature described herein, provided that the remaining sterilized liquid protein supplement still contains all of the required ingredients or features as described herein. In this context, and unless otherwise specified, the term “substantially free” means that the selected sterilized liquid protein supplement contains less than a functional amount of the optional ingredient, typically less than 5% by weight, including less than 4% by weight, including less than 3% by weight, including less than 2% by weight, including less than 1% by weight, including less than 0.5% by weight, including less than 0.1% by weight, and also including zero percent by weight of such optional or selected essential ingredient.

The sterilized liquid protein supplements and corresponding manufacturing methods of the present disclosure can comprise, consist of, or consist essentially of the essential elements and limitations of the disclosure as described herein, as well as any additional or optional ingredients, components, or limitations described herein or otherwise useful in the sterilized liquid protein supplement.

### Product Form

The sterilized liquid protein supplements of the present disclosure may be used as a supplemental source of nutrition and may optionally be in the form of clear or substantially clear liquids. The sterilized liquid protein supplements may be for use as human milk fortifiers or with infant liquid nutritionals, or preterm liquid nutritionals. The sterilized liquid protein supplements of the present disclosure are thin liquids comprising at least protein as discussed below. The sterilized liquid protein supplements are substantially fat free and carbohydrate free; that is, the supplements are devoid of added fat and carbohydrate except for that fat and carbohydrate inherent to the raw materials or added fat or carbohydrate at low concentrations to aid in the manufacture of the sterilized liquid protein supplement. In this context, the term “fat free” and/or “carbohydrate free” means that the sterilized liquid protein supplement typically contains less than 1.0%, more typically less than 0.5%, and more typically less than 0.1%, including zero percent, fat and/or carbohydrate by weight of the sterilized liquid protein supplement.

The sterilized liquid protein supplements of the present disclosure have a solids content of at least about 10%, including from about 10% to about 50%, further including from about 10% to about 40%, and further including from about 15% to about 30%. The sterilized liquid protein supplements are liquids that are capable of being poured directly from a package containing them into human milk, other infant feeding formula, or a combination thereof.

To provide improved stability and shelf-life, it is generally desirable that the sterilized liquid protein supplements of the present disclosure include insoluble solids at a concentration of less than 5 grams per 100 grams of the sterilized liquid protein supplement, including an insoluble solids content of from about 0.5 grams to less than 5 grams per 100 grams of the sterilized liquid protein supplement, or even an insoluble solids concentration of 0 grams per 100 grams of the sterilized liquid protein supplement. Having low insoluble solids contents ensures less precipitation of the solids out of solution (i.e., plugging/fouling) and an improved appearance of the sterilized liquid protein supplements which may be clear or substantially clear.

The sterilized liquid protein supplements may be and typically are shelf-stable. The sterilized liquid protein supplements typically contain up to about 95% by weight of water, including from about 50% to about 95%, also including from about 60% to about 90%, and also including from about 70% to about 85%, of water by weight of the sterilized liquid protein supplement.

The sterilized liquid protein supplements may have a variety of product densities, but most typically have a density greater than about 1.040 g/mL, including from 1.06 g/mL to 1.12 g/mL, and also including from about 1.085 g/mL to about 1.10 g/mL.

The sterilized liquid protein supplements are generally formulated to have a caloric density of at least 0.4 kcal/mL, including at least about 0.8 kcal/mL, including from about 0.4 kcal/mL to about 1.2 kcal/mL, including from about 0.6 kcal/mL to about 1.1 kcal/mL, and including from about 0.8 to about 0.94 kcal/mL.

The sterilized liquid protein supplements are further formulated to have a neutral pH sufficient to reduce or inhibit microbial growth, particularly growth of C. sakazakii, Clostridium botulinum, Salmonella spp., Staphylococcus aureus, and Escherichia coli, as well as many food spoilage microorganisms known in the art. Preferably, the sterilized liquid protein supplements are prepared to have a pH ranging from about 5.0 to about 8.0, but are most advantageously in a pH range of from about 5.5 to about 7.0, and including from about 5.5 to about 6.5.

### Macronutrients

The sterilized liquid protein supplements of the present disclosure comprise protein macronutrients of sufficient types and amounts that, when used in combination with human milk or other infant feeding formula, help meet the nutritional needs of the user, especially the premature infant. The concentration of these macronutrients in the various embodiments of the present disclosure includes the ranges described hereinafter.

### Extensively Hydrolyzed Casein Protein

The sterilized liquid protein supplements of the present disclosure include hypoallergenic extensively hydrolyzed casein as at least one protein source. Generally, the sterilized liquid protein supplements will include at least about 35%, including at least about 50%, including at least about 60%, including at least about 75%, including at least about 90% and further including about 100% or 100% extensively hydrolyzed casein, by total weight of protein in the sterilized liquid protein supplement. In one desirable embodiment of the present disclosure, the sterilized liquid protein supplement includes 100% extensively hydrolyzed casein, by total weight of the protein in the sterilized liquid protein supplement. In this desirable embodiment, the sterilized liquid protein supplement is hypoallergenic. In some embodiments, the sterilized liquid protein supplement will include from about 35% to 100%, including from about 50% to 100%, further including from about 75% to 100% extensively hydrolyzed casein, by total weight of protein in the sterilized liquid protein supplement. As discussed further below, in some embodiments of the present disclosure, the sterilized liquid protein supplements of the present disclosure may optionally include other hypoallergenic or non-hypoallergenic proteins in addition to the extensively hydrolyzed casein protein.

Extensively hydrolyzed casein proteins suitable for use in the sterilized liquid protein supplement of the present disclosure include those having a degree of hydrolysis of from about 20% to about 80%, including from about 30% to about 70%, and further including from about 40% to about 60%. Generally, the extensively hydrolyzed casein has a ratio of total amino nitrogen (AN) to total nitrogen (TN) of from about 0.2 AN to 1.0 TN to about 0.4 AN to about 0.8 TN. Suitable commercially available extensively hydrolyzed caseins will generally have a protein level in the ingredient of from about 50% to about 95%, including from about 70% to about 90%.

### Protein

The sterilized liquid protein supplements of the present disclosure comprise a protein suitable for use in infants, especially preterm infants, at concentrations of more than 10 grams per 100 mL of final sterilized liquid protein supplement, including more than about 12 grams per 100 mL of sterilized liquid protein supplement, and including more than about 14 grams per 100 mL of sterilized liquid protein supplement. In some embodiments, the protein may be at a concentration of from about 14 grams to about 30 grams per 100 mL of sterilized liquid protein supplement, including from about 14 grams to about 27.5 grams per 100 mL of sterilized liquid protein supplement, including from about 15 grams to about 27.5 grams per 100 mL of sterilized liquid protein supplement, including from about 17 grams to about 25 grams per 100 mL of sterilized liquid protein supplement, including from about 17 grams to about 24 grams per 100 mL of sterilized liquid protein supplement, and including from about 20 grams to about 24 grams per 100 mL of sterilized liquid protein supplement. In one desirable embodiment, the protein concentration may be from about 20 grams to about 23.5 grams of protein per 100 mL of sterilized liquid protein supplement.

As noted above, the protein component of the sterilized liquid protein supplements of the present disclosure is at least partially comprised of extensively hydrolyzed casein. In a particularly desirable embodiment of the present disclosure, the protein component of the sterilized liquid protein supplement is entirely comprised of extensively hydrolyzed casein. In embodiments wherein additional protein sources (i.e., one or more protein sources in addition to the extensively hydrolyzed protein source) are to be used in the sterilized liquid protein supplement in addition to the extensively hydrolyzed casein (i.e., the sterilized liquid protein supplement protein component is not 100% extensively hydrolyzed casein), the supplement may still be made hypoallergenic by including additional hypoallergenic proteins such as soy protein hydrolysate, whey protein hydrolysate, rice protein hydrolysate, potato protein hydrolysate, fish protein hydrolysate, egg albumen hydrolysate, gelatin protein hydrolysate, pea protein hydrolysate, bean protein hydrolysate, combinations of animal and vegetable protein hydrolysates, and combinations thereof.

In this context, the terms “protein hydrolysates” or “hydrolyzed protein” are used interchangeably herein and include extensively hydrolyzed proteins, wherein the degree of hydrolysis is most often at least about 20%, including from about 20% to about 80%, and also including from about 30% to about 70%, even more preferably from about 40% to about 60%. The degree of hydrolysis is the extent to which peptide bonds are broken by a hydrolysis method. The degree of protein hydrolysis for purposes of characterizing the extensively hydrolyzed protein component of these embodiments is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

In other embodiments of the present disclosure, the sterilized liquid protein supplement, in addition to the extensively hydrolyzed protein, may include an additional non-hypoallergenic protein source including for example, partially hydrolyzed or non-hydrolyzed (intact) protein, and can be derived from any known or otherwise suitable source such as milk (e.g., casein, whey, lactose-free milk protein isolates), animal (e.g., meat, fish), cereal (e.g., rice, corn), vegetable (e.g., soy, pea, bean), or combinations thereof.

The protein can include, or be entirely or partially replaced by, free amino acids, dipeptides, and/or tripeptides known or otherwise suitable for use in nutritional products. For example, in some embodiments, the protein is at least 50%, including at least 60%, and including at least 75% by weight total protein component, free amino acids, dipeptides and tripeptides. Further, in one desirable embodiment, the protein is at least 75% by weight total protein component, free amino acids. Non-limiting examples of free amino acids include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

While the protein component of the sterilized liquid protein supplement may be derived from various sources as described herein, it should be understood that the sterilized liquid protein supplement may be substantially free of collagen; that is, the supplements may be, in some embodiments, devoid of collagen as a protein source. In this context, the term “substantially free of collagen” means that the sterilized liquid protein supplement typically contains less than 1.0%, more typically less than 0.5%, and more typically less than 0.1%, including zero percent, collagen by weight of the sterilized liquid protein supplement.

### Vitamins and Minerals

The sterilized liquid protein supplements of the present disclosure may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof. In some desirable embodiments, the sterilized liquid protein supplements further include water soluble vitamins such as vitamin B₁₂, niacin, folic acid, biotin, pantothenic acid, and vitamin C.

The sterilized liquid protein supplements may also further comprise any of a variety of minerals known or otherwise suitable for use in infant or other nutritional formulas, non-limiting examples of which include phosphorus, magnesium, calcium, zinc, manganese, copper, iodine, sodium, potassium, chloride, selenium, and combinations thereof.

### Other Optional Ingredients

The sterilized liquid protein supplements of the present disclosure may further optionally comprise other ingredients that may modify the physical, chemical, aesthetic or processing characteristics of the compositions or serve as pharmaceutical or additional nutritional components when used in the targeted population. Many such optional ingredients are known for use in food and nutritional products, including infant formulas, and may also be used in the sterilized liquid protein supplements of the present disclosure, provided that such optional materials are compatible with the essential materials described herein, are safe and effective for their intended use, and do not otherwise unduly impair product performance.

Non-limiting examples of such optional ingredients include preservatives, anti-oxidants, various pharmaceuticals, buffers, carotenoids, colorants, flavors, nucleotides and nucleosides, thickening agents, prebiotics, probiotics, sialic acid-containing materials, and other excipients or processing aids.

### Method of Manufacturing

The sterilized liquid protein supplements of the present disclosure may generally be prepared using the following method: suspending a protein in an aqueous solution using agitation to form a protein suspension mixture having a protein concentration greater than 30% by weight; diluting the protein suspension mixture with water to form a diluted mixture having a protein concentration of from about 25% to about 30% by weight; heating the diluted mixture with agitation; emulsifying the heated mixture; heating the emulsified mixture and holding the emulsified mixture at the heated temperature for a period; cooling the heated emulsified mixture; homogenizing the cooled mixture and holding the homogenized mixture at a cooled temperature for a period; further cooling the homogenized mixture; and diluting the cooled homogenized mixture with water to form a cooled homogenized mixture comprising more than 10 grams per 100 mL protein.

In one or more desirable embodiments, the sterilized liquid protein supplement is prepared by first suspending a protein in an aqueous solution using agitation to form a protein suspension mixture having a protein concentration of greater than 30% by weight, including from about 35% to about 65% by weight, including from about 35% to about 57%, and including from about 45% to about 50% by weight. At least a portion of the protein is extensively hydrolyzed casein. Particularly, in one embodiment, the protein is solely extensively hydrolyzed casein and the extensively hydrolyzed casein is suspended in water at a temperature of from about 120° F. to about 180° F. to make the protein suspension mixture. The casein hydrolysate is added with sufficient agitation to disperse the casein hydrolysate and keep insoluble amino acids/peptides in suspension. While maintaining both the temperature and agitation, additional water is then added to further dilute the protein suspension mixture to a protein concentration of from about 25% to about 30% by weight, including about 27.5% by weight.

The diluted protein suspension mixture is then heated with agitation to a temperature of from about 150° F. to about 210° F., including from about 165° F. to about 175° F. and emulsified at from 0 to about 500 psig, including from 0 to about 300 psig.

The emulsified mixture is then again heated using a two-step heating process. In a first heating step, the emulsified mixture is heated using, for example, an ultra high temperature (UHT) treatment to a temperature of from about 240° F. to about 260° F., including from about 248° F. to about 252° F. A second heating step is then conducted using steam injection UHT to heat the mixture to a temperature of from about 275° F. to about 305° F., including from about 300° F. to about 302° F. The emulsified mixture is held at this second heat temperature for a period of about from about 1 second to about 5 seconds.

The heated emulsified mixture can then be cooled to a temperature of from about 150° F. to about 200° F. In some embodiments, the cooling step is a two-step/stepwise cooling process to prevent precipitation of solids in the mixture. For example, the heated emulsified mixture can first be cooled to a temperature of from about 225° F. to about 265° F., including from about 248° F. to about 252° F., and then the mixture can further be cooled to a temperature of from about 150° F. to about 200° F., including from about 160° F. to about 170° F. to remove steam and water. Any known method of cooling can be used to cool the heated emulsified mixture. One suitable method includes flash cooling.

The cooled mixture is then homogenized at from 0 to about 500 psig, including from 0 to about 300 psig and held at a temperature of from about 150° F. to about 200° F. for a period of from about 10 seconds to about 20 seconds.

The homogenized mixture is then cooled to a temperature of less than 100° F., desirably a temperature of from about 30° F. to about 45° F., including from about 34° F. to about 45° F. Finally, the cooled homogenized mixture is diluted with water to form a liquid protein supplement having a target protein content, such as a protein content of more than 10 grams per 100 mL of final sterilized liquid protein supplement, including more than about 12 grams per 100 mL of sterilized liquid protein supplement, and including more than about 14 grams per 100 mL of sterilized liquid protein supplement. In some embodiments, the protein concentration may be from about 14 grams to about 30 grams per 100 mL of sterilized liquid protein supplement, including from about 14 grams to about 27.5 grams per 100 mL of sterilized liquid protein supplement, including from about 15 grams to about 27.5 grams per 100 mL of sterilized liquid protein supplement, including from about 17 grams to about 25 grams per 100 mL of sterilized liquid protein supplement, including from about 17 grams to about 24 grams per 100 mL of sterilized liquid protein supplement, and including from about 20 grams to about 24 grams per 100 mL of sterilized liquid protein supplement. In one desirable embodiment, the protein concentration may be from about 20 grams to about 23.5 grams of protein per 100 mL of final sterilized liquid protein supplement.

Once diluted to its final protein concentration, the liquid protein is commercially sterilized for long term shelf stability, commonly by either retort or aseptic processing/packaging. The retort packaging can be accomplished using any of a variety of techniques well known to those of ordinary skill in the art, so long as the heat treatment is sufficient (i.e., about 125° C. for about 20-30 minutes) to achieve long term shelf stability of the sterilized liquid protein supplement. Alternatively, the aseptic processing/packaging can be accomplished by using any of a variety of techniques well known to those skilled in the art so long as the heat treatment (i.e., about 145° C. for 5 seconds) and packaging conditions are sufficient to achieve and maintain commercial sterility.

### Method of Use

The sterilized liquid protein supplement of the present disclosure is used in combination with human milk or other suitable infant formula, wherein the resulting fortified human milk or fortified infant formula has an osmolality suitable for oral administration to an infant. The osmolality will most typically be less than about 500 mOsm/kg water, more typically from about 300 mOsm/kg water to about 400 mOsm/kg water.

The sterilized liquid protein supplements of the present disclosure may be added directly to human milk or infant formula in a volume to volume ratio of from about 1 mL sterilized liquid protein supplement to 100 mL of human milk or formula to about 5 mL sterilized liquid protein supplement to 100 mL of human milk or formula, and including about 3 mL sterilized liquid protein supplement to 100 mL of human milk or formula. The ratio is ultimately selected based primarily upon the ingredients and concentration of the sterilized liquid protein supplement and in view of the particular nutritional needs of the infant. The sterilized liquid protein supplements may be added directly to every feeding or to a sufficient number of feedings (e.g., once or twice daily) to provide optimal nutrition in view of the particular nutritional needs of the infant.

Human milk or other infant feeding formula, after fortification with the sterilized liquid protein supplement will most typically have a caloric density ranging from about 11 kcal/fl oz (0.4 kcal/mL) to about 35 kcal/fl oz (1.2 kcal/mL), including from about 19 kcal/fl oz (0.64 kcal/mL) to about 30.0 kcal/fl oz (1.0 kcal/mL) with the 22-26.7 kcal/fl oz formulations (0.74-0.90 kcal/mL) being more useful in preterm infants, and the 19-21 kcal/fl oz (0.64-0.71 kcal/mL) formulations more useful for term infants.

The methods of the present disclosure therefore include a method of providing nutrition to infants, especially preterm infants, said method comprising the addition of the liquid protein supplement to human milk or other infant feeding formula, followed by the administration of the fortified human milk or feeding formula to the infant.

### EXAMPLES

The following examples illustrate specific embodiments and/or features of the sterilized liquid protein supplements of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

### Example 1

In this Example, a sterilized liquid protein supplement is prepared using the methods of the present disclosure.

Specifically, extensively hydrolyzed casein was suspended in water at a temperature of from about 120° F. to about 180° F. to make a protein suspension mixture having a protein concentration of about 49% by weight. The casein was added with sufficient agitation to disperse the casein and keep insoluble amino acids/peptides in suspension. While maintaining both the temperature and agitation, additional water was then added to further dilute the protein suspension mixture to a protein concentration of about 27.5% by weight. The diluted mixture was then heated to a temperature of from about 165° F. to about 175° F. and emulsified at from 0 to about 300 psig. The emulsified mixture was then again heated using a two-step heating process. In the first heating step, the emulsified mixture was heated using an ultra high temperature (UHT) treatment to a temperature of from about 248° F. to about 252° F. A second heating step was then conducted using steam injection UHT to heat the mixture to a temperature of from about 300° F. to about 302° F. The emulsified mixture was held at this temperature for a period of about 5 seconds.

The heated emulsified mixture was then flash cooled to a temperature of from about 248° F. to about 252° F. to remove steam and water. The mixture was then further cooled to a temperature of from about 160° F. to about 170° F. The cooled mixture was then homogenized at from 0 to about 300 psig and held at a temperature of from about 165° F. to about 185° F. for a period of about 16 seconds.

The homogenized mixture is then cooled to a temperature of from about 34° F. to about 45° F. Finally, the cooled homogenized mixture was diluted with water to form a liquid protein supplement having a target protein content of about 20 grams extensively hydrolyzed casein per 100 mL liquid protein supplement.

The sterilized liquid protein supplement is then filled into a container and retort sterilized.

### Example 2

In this Example, the precipitation of insoluble matter in sterile liquid protein supplements containing various protein concentrations was analyzed.

Sterilized liquid protein supplements were prepared having various protein concentrations using the method described in Example 1 above. Insoluble matter was determined using centrifugation (31,000× g; 20° C.; 1 hour) and loss on drying. Free amino acids in the supplements were determined by high performance liquid chromatography (HPLC). The results are shown in the table below.

Precipitate v. Protein Concentration

| | Liquid Protein | UHT | |
|---|---|---|---|
| | Replicate 1-A | (25% | UHT (20% |
| | (LPR1-A) (33% protein) | protein) | protein) |
| Insoluble matter, | 9.2 | 1.9 | <0.1 |
| g per 100 g | | | |
| supplement | | | |
| Insoluble matter, | 24 | 6.8 | <0.5 |
| g per 100 g total | | | |
| solids | | | |
| Free Leu + Free | 30 | 44 | Not determined |
| Ile, % (w/w) of | | | |
| insoluble matter | | | |
| Free Phe, % | 3.4 | 3.5 | Not determined |
| (w/w) of insoluble | | | |
| matter | | | |
| Free Val, % | 3.5 | 2.4 | Not determined |
| (w/w) of insoluble | | | |
| matter | | | |
| Free Met, % | 3.2 | 4.5 | Not determined |
| (w/w) of insoluble | | | |
| matter | | | |
| Free amino acids, | >40 | >54 | Not determined |
| % (w/w) of | | | |
| insoluble matter | | | |

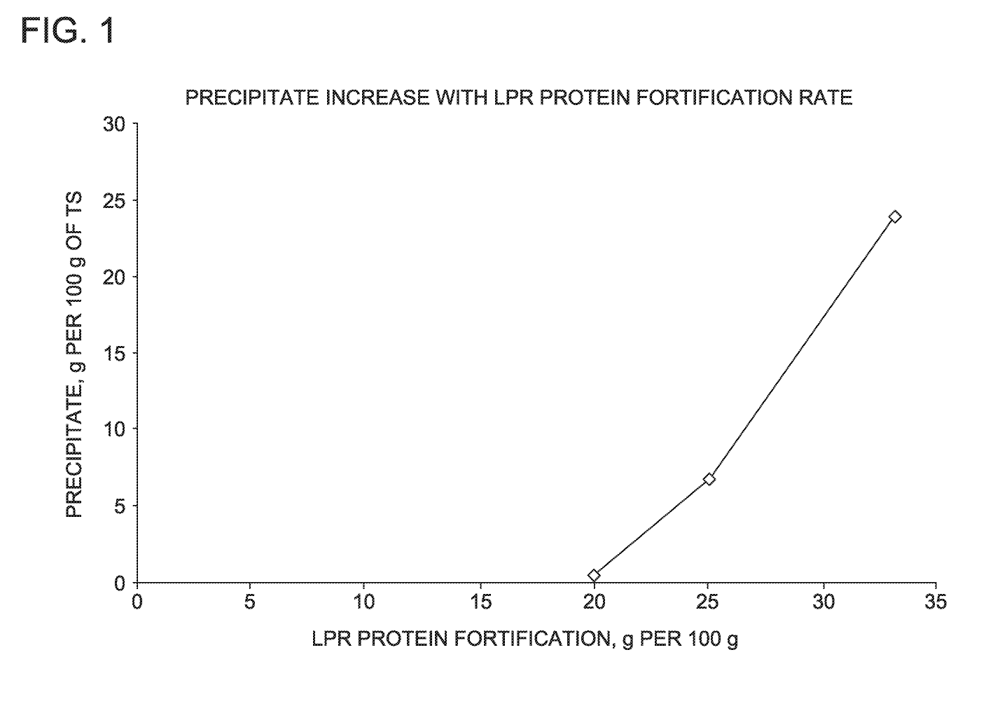

As shown in the table, and further shown in FIG. 1, the precipitation of insoluble matter increased exponentially with increasing protein concentrations. Additionally, free leucine (free Leu) appeared to be the predominant component in the precipitate.

The in-process plugging/fouling that occurs, as well as the post-production precipitation of insoluble matter, occurred because of the solubility limits of the amino acids, which are temperature dependent, have been exceeded as opposed to due to heat-induced chemical modification of the protein (e.g., denaturation).

### Example 3

In this Example, a sterilized liquid protein supplement for use as a human milk fortifier (HMF) was analyzed for molecular weight (MW) profile on two separate days.

Particularly, on day 1, the human milk fortifier was compared to a casein hydrolysate and to a commercially available hypoallergenic infant formula. The MW profiles of the compositions are shown in the table below. In addition to the MW profiles, the MW median was determined for each composition, and the concentration of di-peptides and tri-peptides was estimated (expressed as %, w/w, of total protein), as the hydrolysate fraction corresponding to the peak area ranging from 180 to 420 Daltons.

Day 1 Comparison: HMF v. Casein Hydrolysate and Commercially
Available Hypoallergenic Infant Formula

| | | | Commercially |
|---|---|---|---|
| | | | Available |
| MW Range, | | Casein | Hypoallergenic |
| Daltons | HMF | Hydrolysate | Infant Formula |
| >5000 | 0.1% | 0.0% | 0.0% |
| 3000-5000 | 0.3% | 0.2% | 0.2% |
| 1000-3000 | 7.6% | 6.3% | 6.0% |
| 500-1000 | 20.3% | 20.2% | 17.6% |
| 250-500 | 25.8% | 30.8% | 26.6% |
| <250 | 45.9% | 42.5% | 49.6% |
| Total | 100.0% | 100.0% | 100.0% |
| MW median, | 286 | 303 | 254 |
| Daltons | | | |
| 180-420 Daltons | 28.6% | 34.4% | 31.9% |
| (estimate of di- | | | |
| peptides and tri- | | | |
| peptides) | | | |

On day 2, a different casein hydrolysate and two commercially available hypoallergenic infant formulas were analyzed with the human milk fortifier. The MW profiles of these compositions are shown in the table below.

Day 2 Comparison: HMF v. Casein Hydrolysate and Commercially
Available Hypoallergenic Infant Formula

| | | | Commercially | Commercially |
|---|---|---|---|---|
| | | | Available | Available |
| | | | Hypoallergenic | Hypoallergenic |
| MW Range, | | Casein | Infant | Infant |
| Daltons | HMF | Hydrolysate | Formula 1 | Formula 2 |
| >5000 | 0.1% | 0.0% | 0.1% | 0.0% |
| 3000-5000 | 0.3% | 0.2% | 0.3% | 0.2% |
| 1000-3000 | 7.6% | 6.5% | 6.2% | 6.1% |
| 500-1000 | 20.2% | 17.8% | 18.9% | 19.7% |
| 250-500 | 25.8% | 29.9% | 26.76% | 28.0% |
| <250 | 46.0% | 45.6% | 47.8% | 46.0% |
| Total | 100.0% | 100.0% | 100.0% | 100.0% |
| MW median, | 285 | 279 | 268 | 281 |
| Daltons | | | | |
| 180-420 | 29.1% | 34.5% | 30.2% | 31.1% |
| Daltons | | | | |
| (estimate of di- | | | | |
| peptides and | | | | |
| tri-peptides) | | | | |

### Example 4

In this Example, the published essential amino acid profiles of various protein sources are provided in the table below.

Essential Amino Acid Concentrations as g per 100 g of protein

| Essential | | | Dellac CE-90 | FAO/WHO |
|---|---|---|---|---|
| Amino Acid | Casein^{a} | Yeast^{b} | HM^{c} | 1985^{d} |
| Threonine | 4.2 | 4.7 | 4.5 | 4.3 |
| Met + Cys | 3.0 | 2.4 | 3.2 | 4.2 |
| Valine | 6.7 | 4.8 | 6.6 | 5.5 |
| Isoleucine | 5.6 | 4.2 | 5.2 | 4.6 |
| Leucine | 9.7 | 6. | 9.1 | 9.3 |
| Tyr + Phe | 9.9 | 6.5 | 5.5 | 7.2 |
| Lysine | 7.3 | 8.0 | 8.1 | 6.6 |
| Histidine | 2.7 | 4.2 | 2.6 | Not Specified |
| Tryptophan | 1.2 | 1.2 | 0.8 | 1.7 |
| Total | 50.3 | 42.0 | 45.6 | 43.4+ |

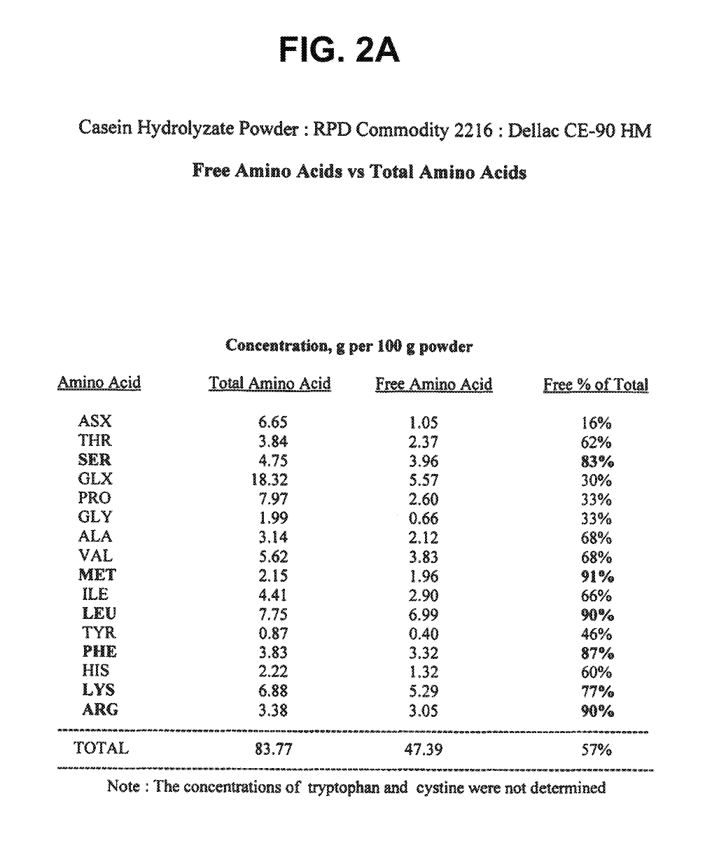

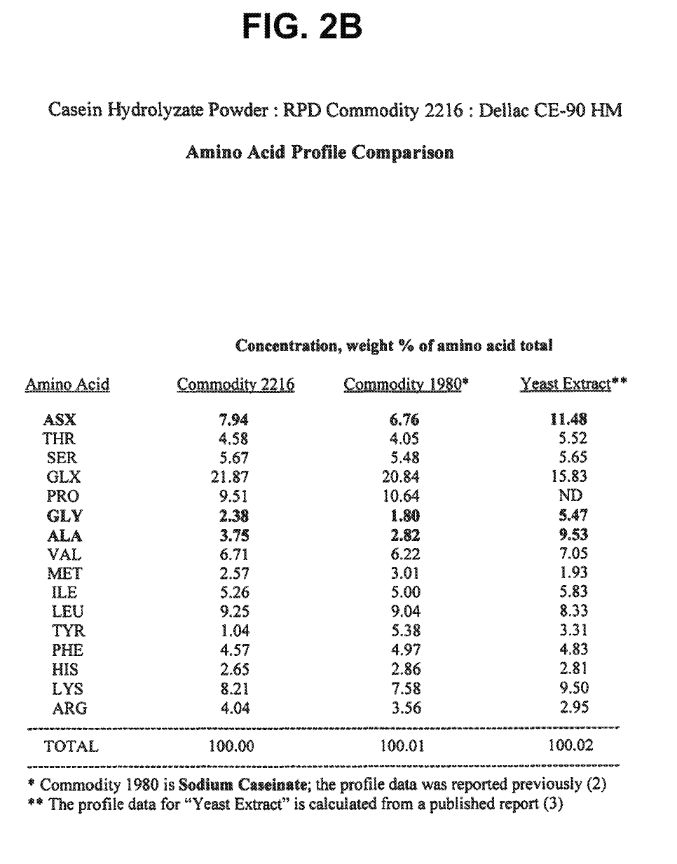

^{a}averages from two independent sources (Walstra, et al., “Dairy Chemistry and Physics,” 1984, John Wiley & Sons, New York, pp. 402-403; Heine, et al., J. Nutr, 121 (191) 277-283)
^{b}whole cells, Saccharomyces cerevisiae
^{c}Casein hydrolysate (available from Abbott Nutrition (Columbus, Ohio)) Amino Acid profile provided in FIGS. 2A and 2B
^{d}recommended requirements for infants 3-6 months old

Although the addition of yeast protein (estimated at 10-15% of total protein in the source) to the casein protein source may increase the final commodity concentrations of three essential amino acids (i.e., threonine, lysine, and histidine), the effect of yeast protein on the overall protein quality of the source did not appear to be significantly positive.

### Example 5

In this Example, the buffering strength of a sterile liquid protein supplement of the present disclosure was determined and compared to the buffering strengths of related nutritional products.

A sterile liquid protein supplement was prepared using the method of Example 1, to include 20% w/w casein hydrolysate. The buffering strength was determined using the method described in Petschow, et al., U.S. Pat. No. 5,550,106 (Aug. 27, 1996). The results of the analysis are in the table below. As shown below, the liquid protein supplement provides a strong buffering strength, which would be expected to stabilize the pH in the optimum range for probiotic bacteria such as Bifidobacteria.

Buffering Strength Comparison

| | Buffering | Buffering Strength, ratio |
|---|---|---|
| Nutritional | Strength, mL^{a} | v. human milk |
| Human milk | 11.6 | 1.0 |
| Sterile Liquid Protein | 209 | 18 |
| Supplement | | |
| HMF powder, 1 pkg + 50 mL | 16.7 | 1.4 |
| water | | |
| HMF powder, 1 pkg + 25 mL | 31.6 | 2.7 |
| water | | |
| Infant Formula Powder, | 31.0 | 2.7 |
| reconstituted | | |

^{a}mL of 0.10M HCl required to lower the pH of 50 mL to 3.0

Further, in the table below, the estimated concentrations of five amino acids in the sterile liquid protein supplement were compared to their solubility limits at 25° C., and the fortification rate of intact casein protein that would be required to deliver the sterile liquid protein concentration is specified as well (e.g., a casein fortification rate of 168 g/L would be required to deliver a leucine concentration of 16.3 g/L).

Amino Acid Solubility Considerations

| | Leu | Ile | Val | Phe | Tyr |
|---|---|---|---|---|---|
| Estimated | 16.3 | 9.26 | 11.8 | 8.04 | 1.83 |
| concentration | | | | | |
| in sterile | | | | | |
| liquid protein, | | | | | |
| g/L^{a} | | | | | |
| Solubility | 24.26 | 41.2 | 88.5 | 29.6 | 0.453 |
| limit of free | | | | | |
| amino acid, | | | | | |
| 25° C., g/L^{b} | | | | | |
| Sterile liquid | 67 | 22 | 13 | 27 | 400 |
| protein | | | | | |
| concentration, | | | | | |
| % of limit | | | | | |
| Casein | 168 | 150 | 162 | 148 | 30 |
| protein, g/L, | | | | | |
| required to | | | | | |
| match sterile | | | | | |
| liquid protein | | | | | |
| concentration | | | | | |

^{a}based on 20% (w/w) solution, density = 1.05 g/L
^{b}Merck Index, 11^{th} Ed., 1989, Merck & Co., Inc.

### Example 6

In this Example, the sterilized liquid protein supplement of the present disclosure was added to human breast milk and/or infant formula and the pH of the resulting composition was analyzed.

A sterilized liquid protein supplement was prepared using the method of Example 1, to include 33% w/w casein hydrolysate. The supplement was added to human breast milk and/or infant formula as set forth in the table below. The pHs of the resulting compositions were analyzed.

TABLE

| | S- | S- | S- | SLF- | SLF- | SLF- | S- | SLF- | C- | SPF- | C- | C- | SPF- | SPF- | SPF- |
|---|---|---|---|---|---|---|---|---|---|---|---|---|---|---|---|
| | I | W | P | I | W | P | 24 | 24 | 24 | 24 | I | P | I | W | P |
| pH | 6.5 | 6.5 | 6.5 | 6.5 | 6.5 | 6.5 | 6.5 | 6.5 | 6.5 | 6.5 | 6.5 | 6.5 | 6.5 | 6.5 | 6.5 |

S = Frozen, thawed, Human Milk (25 mL) + supplement (1 mL)
SLF = Frozen, thawed, Human Milk (2 mL) + supplement (1.3 mL) + liquid Similac ® human milk fortifier (5 mL)
C = Similac ® Special Care 24 (25 mL) + supplement (1 mL)
SPF = Frozen, thawed, Human Milk (25 mL) + supplement (1 mL) + powdered Similac ® human milk fortifier (1 packet)
I = initial (composition immediately tested upon mixing)
W = composition warmed in water bath prior to testing
P = composition is pumped through tube prior to testing)
24 = composition refrigerated for 24 hours prior to testing

As shown in the table, the final compositions including the sterilized liquid protein supplement and the human breast milk and/or infant formula have a pH of 6.5.

What is claimed is:

1. A method of providing nutrition to an infant, the method comprising:
a) adding a sterilized liquid protein supplement to human milk or other infant formula to form a fortified feeding; and
b) administering the fortified feeding to the infant,
wherein the sterilized liquid protein supplement comprises:
i) more than 10 grams of protein per 100 mL of the sterilized liquid protein supplement;
ii) less than 1% by weight carbohydrate; and
iii) less than 1% by weight fat,
wherein at least 35% by weight of the protein is provided by a hydrolyzed casein having a degree of hydrolysis of at least 20%,
wherein the sterilized liquid protein supplement has a pH of from about 5.0 to about 8.0, and
wherein the sterilized liquid protein supplement has a caloric density of about 0.4 kcal/mL to about 1.2 kcal/mL.

2. The method of claim 1, wherein the infant is a preterm infant or a low birth weight infant.

3. The method of claim 1, wherein the fortified feeding has an osmolality of less than 500 mOsm/kg water.

4. The method of claim 1, wherein at least 75% by weight of the protein in the sterilized liquid protein supplement is provided by the hydrolyzed casein.

5. The method of claim 1, wherein 100% by weight of the protein in the sterilized liquid protein supplement is provided by the hydrolyzed casein.

6. The method of claim 1, wherein the sterilized liquid protein supplement comprises from 14 grams to 30 grams of protein per 100 mL of the sterilized liquid protein supplement.

7. A sterilized liquid protein supplement comprising:
more than 10 grams of protein per 100 mL of the sterilized liquid protein supplement;
less than 1% by weight carbohydrate; and
less than 1% by weight fat;
wherein at least 75% by weight of the protein is provided by a hydrolyzed casein having a degree of hydrolysis of at least 20%;
wherein the sterilized liquid protein supplement has a pH of 5.0 to 8.0; and
wherein the sterilized liquid protein supplement has a caloric density of 0.4 kcal/mL to 1.2 kcal/mL.

8. The sterilized liquid protein supplement of claim 7, which comprises from 14 grams to 30 grams of protein per 100 mL of the sterilized liquid protein supplement.

9. The sterilized liquid protein supplement of claim 7, wherein the protein is 100% by weight hydrolyzed casein.

10. The sterilized liquid protein supplement of claim 7, which comprises from 10% by weight to 50% by weight of solids.

11. The sterilized liquid protein supplement of claim 10, which comprises less than 5 grams of insoluble solids per 100 grams of the sterilized liquid protein supplement.

12. The sterilized liquid protein supplement of claim 7, wherein the sterilized liquid protein supplement is clear.

13. A sterilized liquid protein supplement comprising:
more than 10 grams of protein per 100 mL of the sterilized liquid protein supplement;
less than 1% by weight carbohydrate; and
less than 1% by weight fat;
wherein at least 75% by weight of the protein is provided by free amino acids;
wherein the sterilized liquid protein supplement has a pH of 5.0 to 8.0; and
wherein the sterilized liquid protein supplement has a caloric density of 0.4 kcal/mL to 1.2 kcal/mL.

14. The sterilized liquid protein supplement of claim 13, which comprises from 14 grams to 30 grams of protein per 100 mL of the sterilized liquid protein supplement.

15. The sterilized liquid protein supplement of claim 13, which comprises from 20 grams to 23.5 grams of protein per 100 mL of the sterilized liquid protein supplement.

16. The sterilized liquid protein supplement of claim 13, which comprises from 10% by weight to 50% by weight of solids.

17. The sterilized liquid protein supplement of claim 16, which comprises less than 5 grams of insoluble solids per 100 grams of the sterilized liquid protein supplement.

18. The sterilized liquid protein supplement of claim 13, wherein the sterilized liquid protein supplement is clear.
